(19) United States
(12) Patent Application Publication
(10) Pub. No.: US 2009/0259532 A1
(43) Pub. Date: Oct. 15, 2009

(54) PEER-TO-PEER COMPENSATION IN AN INTENT-COMPENSATION SCHEME

(75) Inventors: Thomas Frank Bergstraesser, Kirkland, WA (US); Brian James Utter, Seattle, WA (US); Kamal Jain, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/101,837

(22) Filed: Apr. 11, 2008

(51) Int. Cl. G06Q 30/00

(52) U.S. Cl. 705/14

(57) ABSTRACT

System(s) and method(s) are provided that facilitate intrinsically targeted, dependable peer-to-peer referral and compensation within an intent-compensation scheme. The referral system synergistically exploits trust mechanisms existing among a referring agent and a referred agent in order to generate high-quality referrals based on a determination of commercial intent from the referred agent. In exchange of conveyed intent at a time of a transaction with a referred agent, system platform directly compensates both the referred agent and the referring agent. Compensation of the referred agent is ensured via tracking mechanism that can identify a referral originating device. Information associated with referral(s) is scoped through privacy profiles, and referral/compensation integrity is maintained via an antifraud component and a tracking component that can identify referring and referred agents. Compensation can be funded trough advertisement spend.

### TECHNICAL FIELD

The subject specification relates to systems and methods for engagement-based compensation of an agent that refers a peer agent to a service platform according to a known intent of the peer agent.

### BACKGROUND

In conventional user-service provider interaction, a user or agent selects a service or goods provider based on an expectation that the provider would deliver relevant and competent service that would satisfy the needs of the agent. In addition, cost-benefit analysis generally contributes to the selection process, with the agent seeking the most value among available alternative. Once a selection is made—either a service provider is engaged in a commercial transaction, or a product is bought from a merchant—the agent conveys intent in accessing the service or utilizing a product. In response to the provided intent, an adequate selection of service provider or product generally leads service or product satisfaction. In such a commercial paradigm, service providers and merchants typically compete for agent's intent by offering quality service and products while campaigning for brand recognition and awareness, as well as service or product differentiation. It should be appreciated, notwithstanding that advertising efforts and agent's intent are either primarily disjointed or marginally exploited. Furthermore, merchants and product distributors generally pursue independent advertisement campaigns.

The disjointed nature between agent's intent and advertiser effort is also reflected in systems or models that exploit “word of mouth” advertising which is perhaps the first form of advertisement, and can certainly be considered the most effective in terms of engagement rate, e.g., number of customers engaged per advertisement offering. Conventional system utilize (i) referrals among unrelated group of agents, e.g., agents that lack any substantial commonality, (ii) “shotgun shot”-style referrals wherein referrals are aggressively pursued with marginal bias or input provided from referred agents; (iii) compensation associated with successful referrals measured through engagement rates generally reward the referring agent; or (iv) both agents are referred by a compensation provider not necessarily accesses quality referrals.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject specification discloses system(s) and method(s) that provide an intrinsically targeted, dependable peer-to-peer referral and compensation within an intent-compensation scheme. The referral system exploits trust mechanisms existing among a referring agent and a peer referred agent in order to generate high-quality referrals based on a determination of commercial intent from the referred agent. In exchange of conveyed intent at a time of a transaction with a referred agent, the system platform directly compensates both the referred agent and its associated referring agent. Compensation of the referred agent is ensured via tracking mechanism that can identify a referral originating device. Information associated with referral(s) is scoped through privacy profiles provided by agents that can potentially be referred, and referral/compensation integrity is maintained via an antifraud component and a tracking component that can identify referring and referred agents. In an aspect, compensation is funded through advertisement spend collected by the service platform.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a block diagram of an example system for engagement-based compensation of an agent that refers a peer agent to a service platform in accordance with aspects disclosed in the subject specification.

FIGS. 2A and 2B are, respectively, an interaction diagram for peer-to-peer intent-based referral/compensation and a quadrant-realization diagram indicated the possible realizations for a (referral, compensation) 2-tuple.

FIGS. 3A, 3B, and 3C illustrate, respectively, an example referral component and associated intelligent component that data mines pseudo-referrals, a privacy component that can confer a specific functionality to the referral component, and a sketch of relative magnitude of compensation award to a referral and a pseudo-referral in accordance with aspects described in the subject specification.

FIGS. 4A, 4B and 4C illustrate aspects of tracking of a referring agent to ensure compensation is delivered adequately.

FIG. 5 illustrates a block diagram of an example system that utilizes ad spend to compensate a referring agent according to aspects disclosed in the subject specification.

FIG. 6 presents a flowchart of an example method for intent-based peer-to-peer referral/compensation in accordance with aspects described herein.

FIG. 7 presents a flowchart of an example method for effecting a referral in a peer-to-peer according to aspects described in the subject specification.

FIG. 8 presents a flowchart of an example method for tracking referring and referred agents according to aspects set forth herein.

FIGS. 9 and 10 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

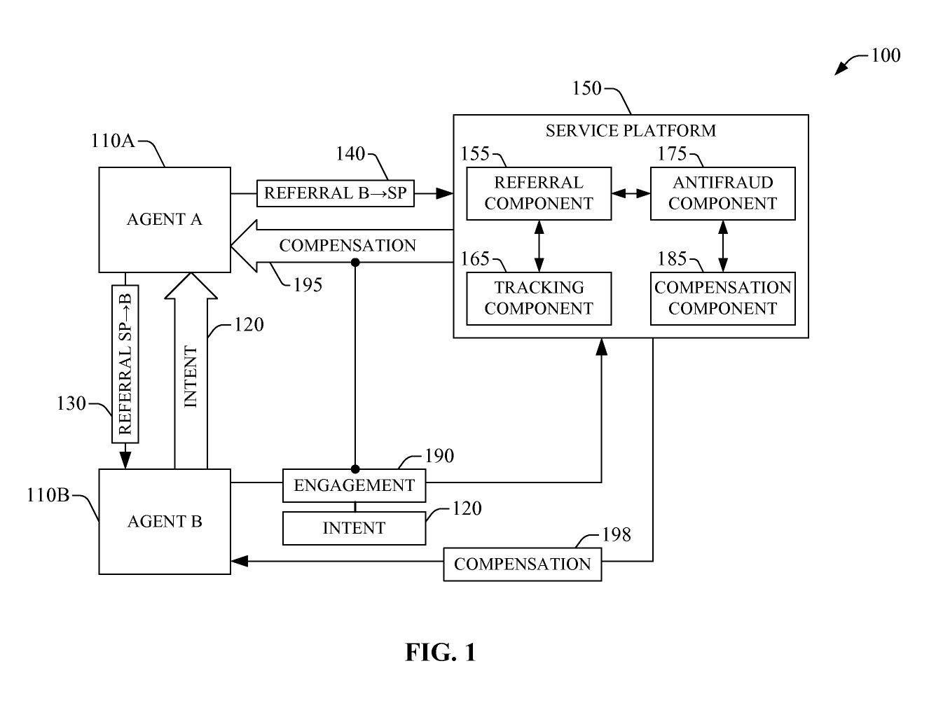

FIG. 1 illustrates a block diagram of an example system 100 that facilitates an engagement-based compensation of an agent that refers a peer agent to a service platform in view of a known intent of the peer agent. In example system 100, agent 110A typically receives an intent 120 from peer agent B 110B. Intent 120 relates generally to commercial intent, e.g., purchasing a merchandise, selecting or subscribing to a service or product, and so on. It is to be noted that the fact that agent B 110B is a peer of agent A 110A, e.g. agents A 110A and agent 110B share commonalities—for example, educational, professional, cultural, or social background; membership to professional, academic and non-academic societies; membership to community groups, worship groups, or environmental organizations; etc.—can lead to a meaningful representation of the intent 120 of agent B 110B. In view of intent 120, agent A 110A can refer a service platform 150 to agent B 110B. In an aspect, such a referral 130 of service platform (SP) 150 to agent B 110B can be conveyed through web-based means, e.g., an “online referral.” However, it should be appreciated that other means such as communication of a SMS (short message service) message through an electronic device can also be utilized to convey referral SP→B 130. In addition, agent A 110A can convey, via referral B→SP 140, to service platform 150 that agent B 110B has been referred thereto. It is to be noted that the peer-to-peer nature of referral 140, which is based on intent 120, exploits an intrinsic trust mechanism among agent A 110A and agent B 110B that is generally absent or not possible in conventional referral schemes. It should be appreciated that conventional online referral systems are “referring agent“-centric rather than “referred agent”-centric as describe above. A referral system 100 exploits at least the following advantages: (i) Knowing a commercial intent; accordingly, targeted referral is intrinsic to the system rather than extrinsic, which would be the case in referral systems that segment referred agents after the referral has occurred. (ii) Relying on a dependability mechanism originated from the fact the agent A 110A and agent 110B are peers. Such a mechanism renders intent-based referral system 100 a more advantageous referral system in connection with eliciting engagement, as the dependability, or trust, mechanism can mitigate concerns with substantially frequent and significant online issues or problems like identity theft, malicious hacker attacks, and so on. Thus, peer-to-peer referrals can mitigate problems associated with security in online transaction.

When agent B 110B engages in a commercial transaction, e.g., engagement 190, as a result of referral SP→B 130, the referring agent 110A receives a compensation 195. Typically, compensation 195 has monetary value; however, non-monetary compensation (e.g., reputation, popularity, peer affinity, distinction) is also contemplated in the subject innovation. Monetary value can be effected (i) directly, e.g., monies are deposited in a compensation account (not shown in FIG. 1) that belongs to agent A 110A, or debt carried by agent A 110A in credit card(s) is reduced by a specific amount—it should be appreciated that such credit card(s) can be issued or managed by service platform 130, which makes debt reduction substantially more affordable and advantageous to the service platform; or (ii) indirectly, such as through reward points, virtual monies or points, e.g., Microsoft® Points, that can be used to claim rewards online and offline. In addition, agent 110A can be compensated with generic points that facilitate claiming products or merchandise of different types and scope. Points, generic or otherwise, can be perishable or perennial, and can be transferred to a third agent (e.g., agent C; not shown). It should be appreciated that, in an aspect, generic points can be managed dynamically by service platform 130, adopting promotional value to drive a specific product or service campaign, or changing scope as a function of the points bearer (e.g., a compensated agent like agent A 110A) engagement level with service platform 130.

With respect to non-monetary compensation, herein termed “soft compensation,” it is to be noted that in systems with a social component such as social networking web portals and, generally, systems wherein success of its components and/or agents is established primary by social factors such as popularity or likeability, reputation or distinction, “soft compensation” can substantially drive traffic and “stickiness” which is metric of service-agent (e.g., service platform 150 and agent A 110A) lock-in or re-engagement over a period of time.

To provide engagement-based compensation 195, service platform can rely in a set of functional components that facilitate implementation of related aspects. Referral component 155.—In order to receive referral B→SP 140, service platform 150 includes a referral component 155 which interface a referring agent with the service platform 150, collects information associated with referred agent B 110B, and embodies a referral by storing it in a computer-readable medium in order to facilitate subsequent tracking of the referral. Referral component 155 can be an interface embodied in multiple aspects; namely, (1) an online access webpage maintained by service platform 150; (2) an electronic interface that can receive SMS messages associated with the referral; (3) an electronic interface that can receive a voice message with information associated to the referral, and digitize the voice message in order to make the information available to other components of service platform 150; and so on.

Tracking component 165.—Once a referral (e.g., referral B SP→140) is received via referral component 155, a tracking component 145 facilitates a posteriori recognition of the referring agent, e.g., agent A 110A, and the referred agent, e.g., agent 110B. In an aspect, tracking component can generate a light-payload file (e.g., a cookie file) and can convey such a file to a device (not shown) utilized by agent 110A to conduct the referral. In another tracking mechanism, when one, or both, of the referring agent and referred agent, is registered with service platform 150, an indication of a referral event can be stored in a memory storage (not shown) associated with the registered user. Such an indication can be an N-bit word, which can be encrypted for fraud mitigation, stored at the kernel level to prevent fraudulent manipulation. Other mechanisms associated with tracking are described in greater detail below.

Antifraud component 175.—In view of the monetary value of compensation or the relevance of non-monetary compensation to various online or offline social interactions, and the collection of agent's information associated with a referral, e.g., referral B→SP 140, service platform 150 includes an antifraud component 175. Such a component manages security features, such as those described above in connection with tracking component 165, that mitigate fraudulent exploitation of compensation 195, either monetary or non-monetary. In an aspect, antifraud component 175 can implement biometric markers (e.g., voice signature, face-features and bio-signatures (like scars, moles, freckles, eye color) recognition, iris recognition) in on-line compensation that can facilitate biometric recognition in order to ensure that an intended agent indeed received an intended compensation. Antifraud component 175 provides substantially all functionality associated with probing biometric features (e.g., high-resolution cameras for bio-feature recognition, fingerprint pads, iris scanners, etc.), encrypting/decrypting online compensation or referral information, etc.

In addition, antifraud component 175 can ensure a referral, e.g., referral B→SP 140, is actually conveyed by a legitimate agent, e.g., agent 110A, instead of an automated script (e.g., a robot) that emulates an agent. In view of the intent-based, peer-to-peer nature of a referral, antifraud component 175 can implement variations of Turing tests to discern whether a malicious agent is conveying the referral; for instance, based on information conveyed to referral component 155, antifraud component 175 can pose questions associated with a professional or academic background of a referred agent. In another aspect, antifraud component 175 can establish if incoming referrals from a specific agent obey a specific pattern, e.g. referrals are conveyed periodically, referrals are pseudo-random instead of truly random as it would be expected from a legitimate agent that refers based on an actual intent 120.

Compensation component 185.—To provide a compensation, e.g., compensation 195 in exchange of a referral, or compensation 198 in exchange of intent, service platform 150 includes compensation component 185, which typically operates in conjunction with antifraud component 175. In an aspect, compensation component can issue points (e.g., generic points, reward point, service-specific points (e.g., airmiles), or platform specific points lime Microsoft® Points) and conduct the accounting of points associated with a specific compensation event. In another aspect, compensation component 185 can manage features of issued compensation like changes to face-value of a compensation, e.g., conferring an increased, promotional value to a compensation if specific actions are taken by a referring agent like referring a disparate agent that generates a substantial revenue to the service platform. In yet another aspect, compensation component 185 can determine specific compensation according to agent intelligence available to service platform 150, in order to mitigate referral attrition, or increase the quality of referrals. In a further yet aspect, compensation component 165 can broker partnerships with disparate online merchants. In still yet another aspect, compensation component can reduce the face-value of issued compensation at the request of antifraud component 155 in order to mitigate fraudulent collection of quality compensation through counterfeit referrals.

It should be appreciated that example system 100 illustrates an intrinsically targeted dependable referral system that is referred-agent-centric and relies on commonalities present among peer agents. The referral system synergistically exploits trust mechanisms existing among a referring agent and a referred agent in order to generate high-quality referrals based on a reliable determination of commercial intent from the referred agent. In exchange of conveyed intent at a time of a transaction with a referred agent, system platform delivers high quality compensation to the referral agent and the referring agent. By promoting referrals through customized compensation (e.g., compensation 195 or compensation 198) based on referral information, service platform 150 can increase market share, and brand and service product recognition among agents.

Various aspects of associated with peer-to-peer intent-based referrals and associated rebates are discussed next.

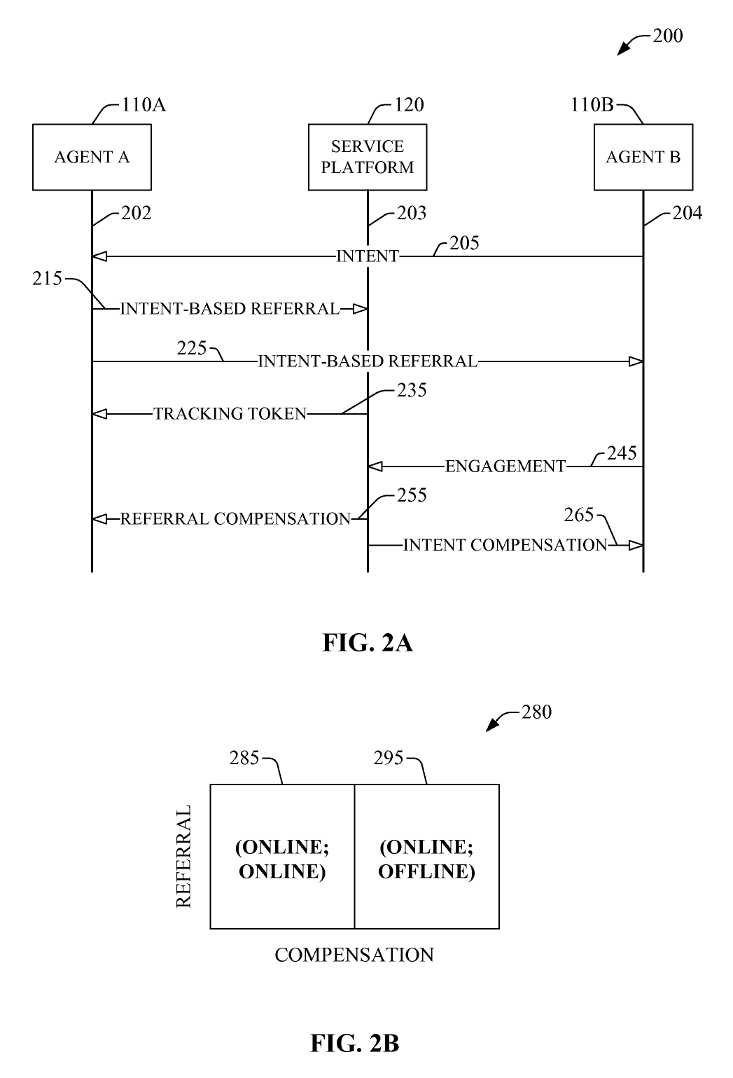

FIG. 2A is an example interaction diagram 200 for peer-to-peer intent-based referral/compensation. It should be appreciated that the interaction depicted in diagram 200 is only illustrative, and additional interactions can be included without departing from the notion(s) that diagram 200 intends to convey. As it is commonly known in the art, each entity in an interaction diagram possesses an event line, such event line generally indicates whether an event is an originating event (no arrow point) or a receiving event (arrow head point), in addition, as a line extends away from the entity an chronology of events is indicated. In example interaction diagram 200, agent B 110B conveys intent 205 to agent A 110A, in response agent A 110A conveys an intent-based referrals 215 and 225 to service platform 150 and agent B 110B, respectively. It should be appreciated that, in an aspect, agent A 110A can evaluate various service platforms prior to conveying a referral to agent B 110B; in particular, the peer-to-peer characteristic of the referral makes the same a highly targeted message. In response to intent-based referral 215, service platform 120 conveys a tracking token, which can be utilized to ensure a legitimate compensation is awarded to referring agent A 110A upon a transaction associated with referred agent B 110B takes place. In response to the highly targeted intent-based referral 225, agent B 110B can engage in a transaction with service platform 150. It should be appreciated that such an engagement can convey the intent 205 that originate the intent-based referral 215. In response to the engagement 245, service platform 150 compensates (e.g., conveys a rebate) referring agent A 110A via a referral compensation 255, while referred agent also receives an intent-based compensation 265. It should be appreciated that compensation of the referred agent, agent B 110B, is based on intent which need not be a purchase or an agreement of service(s)—e.g., intent can be conveyed without exchange of monetary instruments between referred agent B 110B and service platform 120.

FIG. 2B is a quadrant-realization diagram 280 that indicates possible realizations for a (referral, compensation) 2-tuple. In an aspect, a peer-to-peer referral/rebate system (e.g., system 100), a referral such as referral B→SP 140 is typically articulated online, by conveying the referral through a wide-area network (e.g., the internet) communication link. It should be appreciated that the communication link can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. Alternatively or in addition, compensation can be realized or claimed either online or offline; however, it should be appreciated that reward points, or substantially any other tokens associated with materializing a compensation, are conveyed over a network communication link. Accordingly, there are typically two realization quadrants associated with the (referral, compensation) 2-tuple: (online, online) 285 and (online, offline) 295.

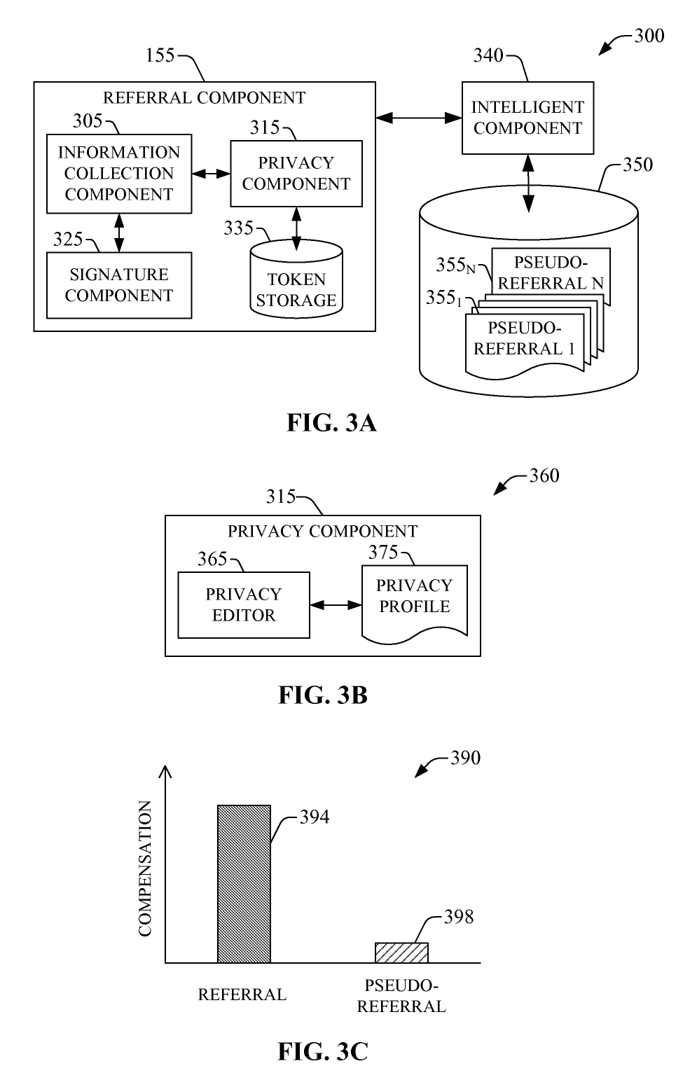

FIG. 3A illustrates an example referral component and associated intelligent component that data mines pseudo-referrals. Referral component 155 comprises an information collection component 305 that retrieves information from a referring agent, e.g., agent A 110A. Typically, such information is conveyed during a referral B→SP 140. Information that is allowed to be collected by service platform 130, through referral component 155, is determined by a privacy component 315, which allow agents that can potentially be referred to establish a privacy policy. Once information about a referred agent, e.g., agent B 110B, a signature component 325 facilitates a referring agent, e.g., agent A 110A, to indicate the source of the information and, alternatively or in addition, to enter a voice signature which can be exploited for tracking purposes. Once the referral is executed, a token associate with the referral can be generated and stored in a token component 335.

It should be appreciated that in order to refer an agent, system platform 150 can require a registration process. In such a registration processor, agent intelligence is collected. In an aspect, to facilitate the registration process, service platform 150 can provide a specific “sign-up bonus” compensation to agents that registers. Referral component 155 can exploit accumulated agent intelligence collected through the registration process to generate a set of pseudo-referrals, e.g., to generate a set of information containers associated with agents known to the system that can express similar intent(s) a the intent associated with a peer-to-peer referred agent. To generate a set of pseudo-referrals, referral component 155 can utilize intelligent component 340 to generate pseudo-referrals 355₁-355_{N}. Pseudo-referrals can be stored in a memory 350 which can reside in service platform 150.

Intelligent component 340 can reason or draw conclusions about agents that would share the intent of a referred agent, such an inference can be based on agent intelligence available to referral component 155. Thus, intelligent component 340 can infer a group of pseudo-referrals, e.g., agents known to service platform 150 (e.g., known via the registration process discussed above) that are likely to possess commercial intents similar to the high-quality intent associated with a peer-to-peer referral. In addition, intelligent component 235 can generate a probability distribution of specific states of an agent (e.g., likelihood a pseudo-referred agent shares the intent of a referred agent) associated with an originating referral (e.g., referral 140) without human intervention.

To infer intent 120, intelligent component 235 relies on artificial intelligence techniques, which apply advanced mathematical algorithms—e.g., decision trees, neural networks, regression analysis, cluster analysis, genetic algorithm, and reinforced learning—to a set of available (as it can be determined by privacy component 215) information on the agent 110, or a system that include the agent.

In particular, the intelligent component 235 can employ one of numerous methodologies for learning from data and then drawing inferences from the models so constructed, e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

FIG. 3B illustrates an example privacy component 315 that is part of an example referral component 155. Privacy component 315 can comprise a privacy editor 365 which facilitates establishing a privacy profile 375. Privacy editor 315 can exploit a graphical user interface (not shown) to facilitate an agent (e.g., agent B 110B) to opt for a predetermined level of privacy with respect to the information that can be disclosed in connection to a referral made by a peer agent (e.g., agent A 110A). Alternatively, or in addition, privacy editor can be provided through a webpage maintained by service platform 130 in connection with an information collection component 305 in a referral component 155. It should be appreciated that privacy editor can be accessed asynchronously and as often as an agent desires. In addition, an agent can be prompted to update its privacy profile prior to a referral being effected by a referring agent (e.g., agent A 110A). Once an agent determines a privacy setting, privacy editor can save the settings in a privacy profile 375 which can be encrypted, e.g., by antifraud component 175. It should be appreciated that an agent can categorize, or segment, its privacy settings in order to establish the information that different referring agents can convey during referral. Accordingly, an agent can allow peer agents different degrees of detail on referrals. For example, an agent can determine a low level of privacy for long-time friends who typically may have a solid understanding of the referred agent values and appreciation for privacy, whereas the agent can suppress substantially all information that can be conveyed by a fellow church attendant with whom the agent is a peer but has a substantially more superficial relationship.

FIG. 3C is a sketch of the relative magnitude of a compensation award to a referring agent, e.g., agent A 110A, when an a referral conveyed by the referring agent results in an engagement, and the compensation associated with an engagement originated in a pseudo-referral as described above in connection with FIG. 3A. In an aspect, compensation associated with an actual referral (e.g., agent B 110B) can have a face-value 394 substantially higher (e.g., 8-fold higher in diagram 390) than the face-value 398 of a compensation issued as a result of an engagement originating from a pseudo-referral. It should be appreciated that the disparity among compensation value can arise primarily from the fact that pseudo-referrals do not exploit entirely the trust mechanism typical of a full peer-to-peer referral and thus the quality of a pseudo-referral can be substantially lower than the quality of an actual referral.

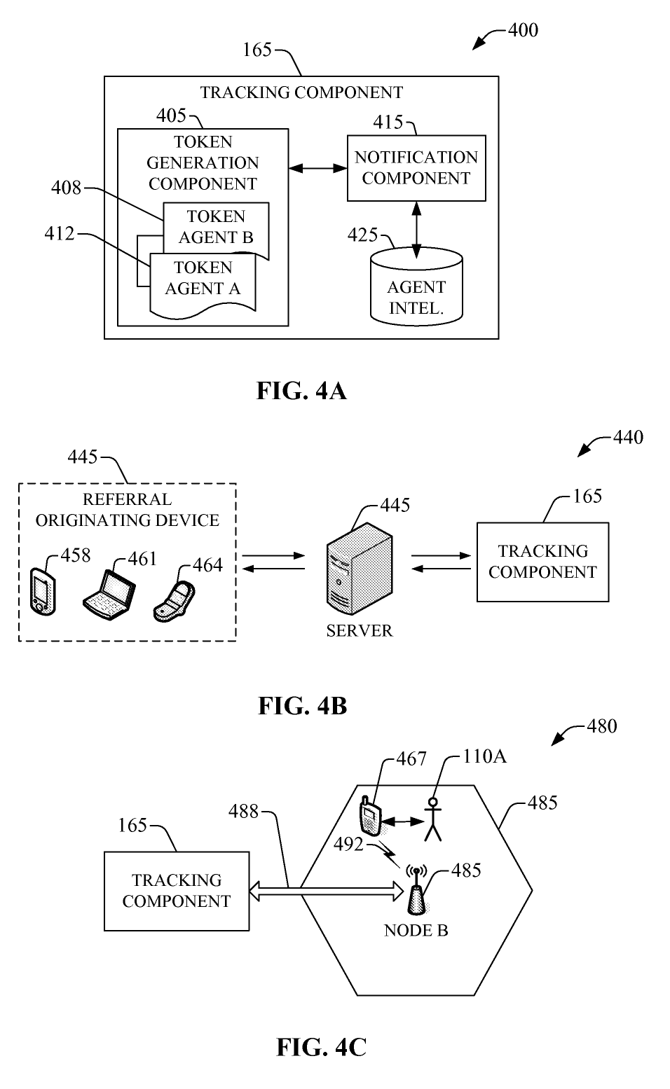

FIG. 4A is a block diagram of tracking component utilized to track a referring agent, agent A 110A, and a referred agent, e.g., agent B 110B. Illustrative tracking component 165 comprises a token generation component 405 that can generate identification, e.g., a token, for a referring agent and a referred agent. Generally, identification, or a token, can be a cookie file associated with a device utilized by the referring agent, e.g., agent A 110A. Additionally, token generation component generates identification for a referred agent, e.g., agent B 110B, to monitor engagement of the referred user with service platform 150. In an aspect, token generation component 405 generates a token pair: token A 408 and token B 412. Such pair of token as uniquely linked to ensure that both referring and referred agents are adequately recognized and compensation is awarded according to aspects described herein. It should be appreciated that agent's identification can be conveyed to an identified agent through notification component 415. Additionally, notification component can retain a record of the identification in an agent intelligence memory 425. It is to be noted that additional information related to a set of agents can be stored in agent intelligence store 425; in particular, information stored in such a memory can be utilized by intelligent component 340 to determine a set of pseudo-referrals.

FIG. 4B is a diagram 440 that illustrates a mechanism that facilitates recognizing an agent, either, or both, a referring or referred agent. In the illustrative mechanism, tracking component 165 conveys an agent's identification to a server 445. Such a server can be an “in the cloud” server which provides access to agent's identification, e.g., a cookie file, to multiple devices associated with an agent; for example referring agent A 110A. In the scenario depicted by diagram 440, a set 455 of referral originating devices is illustrated. Device tracking set 455 comprises a personal digital assistant (PDA) 458, a laptop computer 462, and a cell phone 464. It should be appreciated that by exploiting server 445 a single set of identification can be employed for multiple devices that an agent can utilized. Such an identification mechanism requires, however, that a user registers the set of devices 455 with service platform component, e.g., through tracking component 165. Registration of a device can be conducted at the time of entering a referral via a device that has not been previously registered with the service platform 150. Device registration information can be stored in agent intelligence store 425.

FIG. 4C illustrates an example notification scenario 480 that is part of tracking within a peer-to-peer referral system 100, and facilitates tracking of a referring agent, and it also provides with “compensation alerts” when a compensation has been awarded to the agent. It should be appreciated that alternative scenarios are also possible. In illustrative scenario 480 tracking component 165 conveys a notification message, e.g., a token or a compensation alert, to an agent's device 466. Such a device is wireless and can be included in a tracking device set 455 associated with the agent, e.g., agent A 110A. Communication of the notification can proceed through a (typically wired) backhaul communication link 488, which facilitates communication with a node B 485 via an IP-based, packet switched protocol. Node B 485 provides wireless communication coverage to a service cell 485, which is illustrated as a typical hexagonal service cell. Notification is conveyed to agent 110A via wireless communication link 492. It should be appreciated that in scenarion 480, agent 110A can communicate back with tracking component, and thus service platform component 150 through wireless (reverse) link 492 and backhaul link 488.

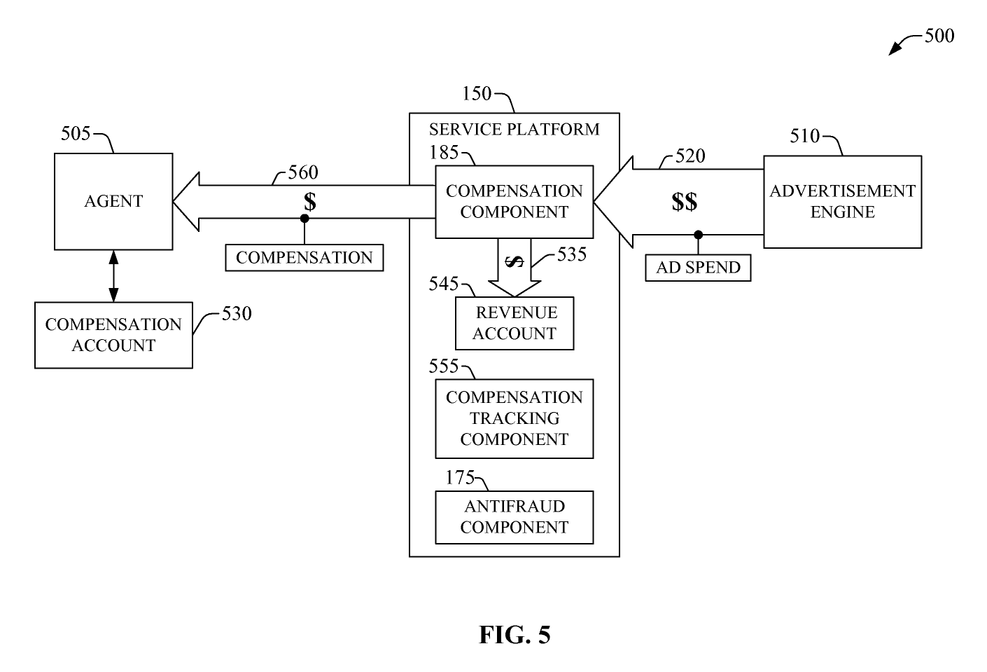

FIG. 5 illustrates a block diagram of an example system 500 that employs ad spend to compensate a referring agent, e.g., agent A 110A, in exchange of an engagement of a referred agent, e.g., agent B 110B, with a service platform (e.g., service platform 150) also referred by the referring agent. In system 500, service platform 150 receives a payment 520 to display advertisements for advertisement engine 510. In an aspect, engine 180 can be part of a merchant which utilizes service platform 150 as an advertisement service or broker. In another aspect, advertisement engine can be an advertisement intermediary between service platform 150 and a set of disparate merchants. In yet another aspect, advertisement engine 510 can be an integral part of, and managed by, service platform 150. In a further yet aspect, compensation component 185 processes ad spend 520 and splits the ad spent 520 in two streams: A portion of the monies 520 directed toward a revenue account 545 of service platform 130, and a remaining portion of the monies are directed towards agent compensation. Compensation monies can be utilized to award an agent 505 a direct payment 560, or can be employed to fund merchandise and product, associated with service platform 150 or a disparate manufactures or service provider. Agent's compensation through a direct payment or reward points can be delivered to a compensation account 530 that belong to the agent. It should be appreciated that while a single agent 505 is illustrated in diagram 500, multiple users can be included in agent 505.

As discussed above, compensation 560 typically possesses monetary value. Depositing compensation 560 in agent's compensation account 530 can facilitate rewarding the agent. Upon delivery of compensation 560 to agent 110, compensation tracking component 555 can account for payments, retain compensation records, store type and quantity of compensation delivered to agent 110, and also monitor a current level of compensation for agent 110 to ensure, for example, compensation fails to surpass a compensation limit. Anti-fraud compensation component 155 operates substantially in the same manner as described above.

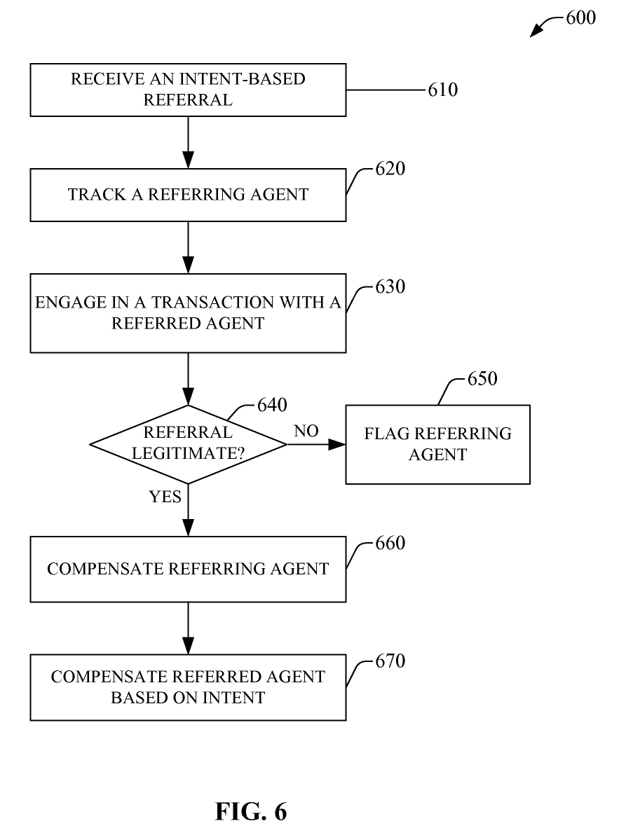

In view of the example systems, and associated aspects, presented and described above, methodologies for compensating a intent-drived referring agent upon engagement of a referred agent with a service platform that may be implemented in accordance with the disclosed subject matter can be better appreciated with reference to the flowcharts of FIGS. 6, 7 and 8. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 6 presents a flowchart of an example method 600 for intent-based peer-to-peer referral/compensation. Illustrative method can be implemented in a service platform, e.g., service platform 150. At act 610 an intent-based referral is received. In an aspect, a first agent can refer a second peer agent as discussed above in connection with interaction diagram 200. At act 620 a referring agent is tracked. Tracking can be accomplished via issuance of a cookie file associated with a device utilized by the referring agent to effect the referral. It should be appreciated that cookie files, or substantially any other tokens, can be issued in pairs in order to identify an agent effecting a referral and an agent that is referred. A tracking component 165 can issue and monitor tracking tokens. At act 630, a referred agent is engaged in a transaction. Such a transaction typically involves a service platform, e.g., service platform 150. Act 640 is a validation act at which the legitimacy of the a referral is probed. An antifraud component such as component 175 can determine whether the referral is legitimate according to various aspects implemented to deter counterfeit referred agent and referring agents. In a situation a referral is found to be counterfeit, the referring agent is flagged in act 650, and multiple ensuing actions can be pursued, such as monitoring an originating device; monitoring an account associated with the referring agent stored in an agent intelligence component, e.g., component 425; increasing active fraud mitigation activities like monitoring referred agents associated with the fraudulent referring agent; pursuing fraud resolution based on the magnitude, frequency, and longevity of the fraudulent activities, and so on. Conversely, at act 660, a referring agent is compensated in case a referral promoted by the referring agent is found to be legitimate. At act 670, a referred agent is compensated based on conveyed intent.

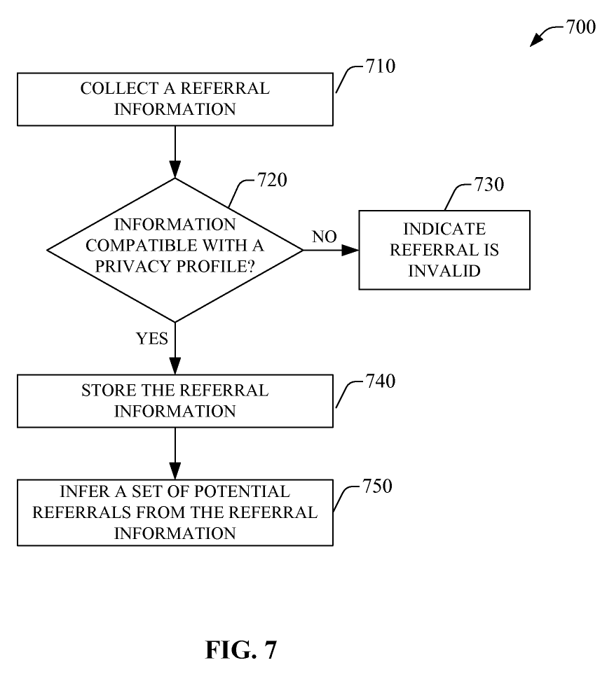

FIG. 7 presents a flowchart of an example method 700 for effecting a referral in a peer-to-peer intent-based referral/compensation model. At act 810, information associated with a referred agent is collected. Such information is typically conveyed online by a referring agent. To mitigate fraud and ensure privacy preservation and integrity, information is collected according to a privacy profile enforced via a privacy component, e.g., component 315. In an aspect, the privacy profile can be determined by an agent that can potentially be referred by a peer agent. Act 720 verifies that collected information is compatible with a privacy profile. In case such verification finds information is incompatible with a privacy profile, the referring agent is made aware accordingly. At act 740, referral information compatible with privacy policies is stored; for instance, information can be stored in agent intelligence memory 425. At act 750, a set of potential referrals, or pseudo-referrals, is inferred from the collected information. In an aspect, supplemental information can be utilized to generate pseudo-referrals, such as information stored in agent intelligence store 425.

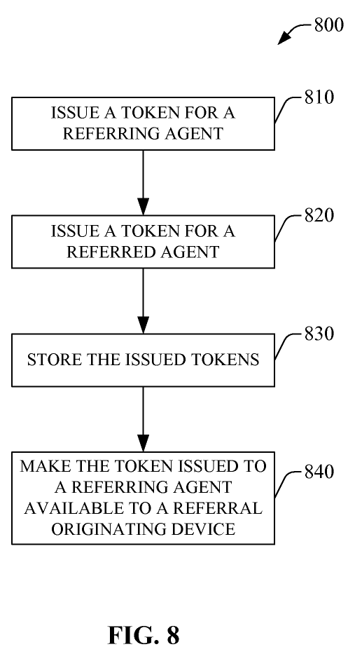

FIG. 8 presents a flowchart of an example method for tracking referring and referred agents according to aspects set forth herein. Typically tracking can be implemented according to method 800 by a tracking component that is part of a service platform, e.g., platform 150 that participates in a peer-to-peer intent-based referral/compensation scheme. In an aspect, tracking is facilitated by tokens issued to both a referring agent and a referred agent. In method 800, at act 810, a token is issued to a referring agent. A token can be a cookie file, a personal identification number conveyed encrypted through a wireless link, a string of random characters in the manner of a private encryption key, or a Q-bit word. At act 820, a token is issued for a referred agent. At act 830, identification tokens are stored. For example, tokens can be stored in stored in a token memory 335.

At act 840 a token issued to a referring agent is made available to a referral originating device. In an aspect, tokens can be first stored in an “in the cloud” server, e.g., server 445, to facilitate access to identification credentials from multiple devices. In another aspect, issued tokens can be conveyed to agent via wired or wireless links.

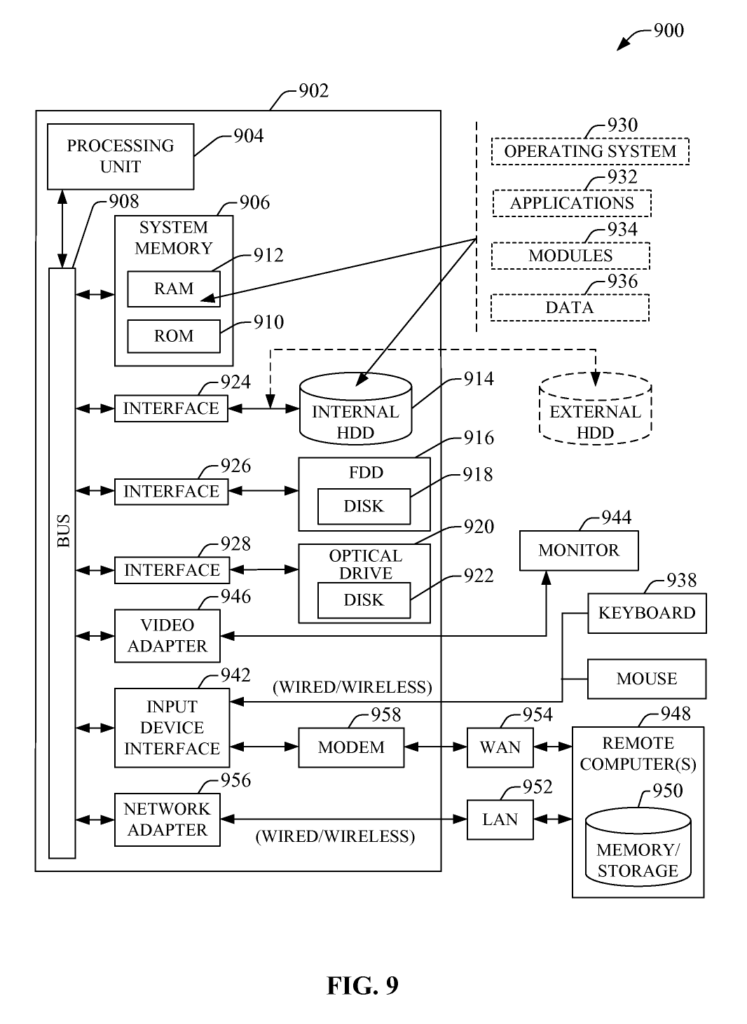

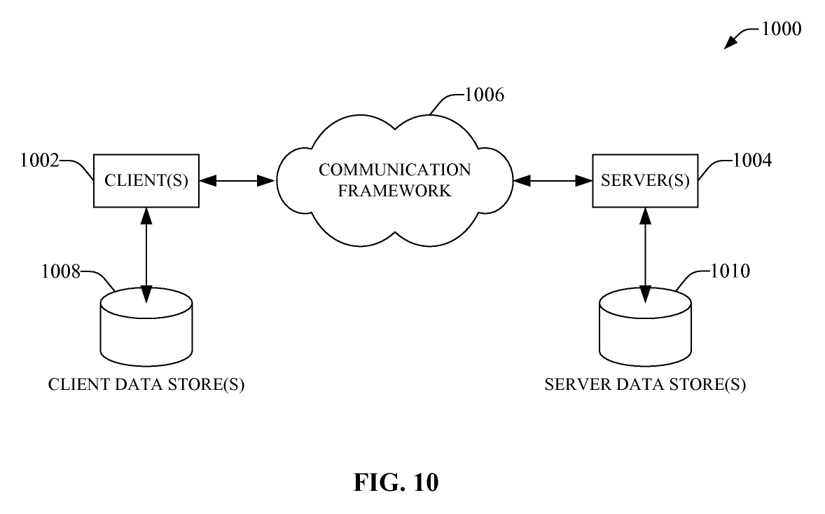

In order to provide additional context for various aspects of the subject specification, FIGS. 9 and 10 and the following discussions are intended to provide a brief, general description of a suitable computing environments in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

In FIG. 9, the example environment 900 for implementing various aspects of the specification includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the specification can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 408 via an interface, such as a video adapter 946. In addition to the monitor 444, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are example and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 10 illustrates a schematic block diagram of a computing environment in accordance with the subject specification. The system 1000 includes one or more client(s) 1002. The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware and/or software (e.g., threads, processes, computing devices). The servers 1004 can house threads to perform transformations by employing the specification, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “possesses,” and the like are used in either the detailed description or the claims, such term is intended to be inclusive in a manner similar to the term “comprising” as “comprising” is interpreted when employed as a transitional word in a claim.

What is claimed is:

1. A system that rewards a peer-to-peer referral of a customer to a service platform, the system comprising:
a referral component that enables an agent to conduct an online intent-based referral, wherein a privacy component enacts a privacy policy associated with the referral;
a tracking component that facilitates identification of a referring agent and a referred agent;
a compensation component that compensates the referring agent through accrued advertising spend the referred agent engages in a transaction as a function of the referral; and
a compensation component that compensates the referred agent through accrued advertising spend in exchange of an agent's intent to transact with a service platform.

2. The system of claim 1, further comprising a fraud component that mitigates fraudulent compensation.

3. The system of claim 1, the referral component further comprising:
a component that collects information; and
a privacy component that determines the information that is collected.

4. The system of claim 1, wherein the tracking component includes a component that generates identification tokens.

5. The system of claim 1, wherein the tracking component conveys an identification token to a server, the server facilitates access to the identification token from a set of referral originating devices.

6. The system of claim 5, wherein the set of referral originating devices are registered with the service platform.

7. The system of claim 1, wherein a pair of generated tokens link a referring agent and a referred agent.

8. The system of claim 4, further comprising a storage component that retains identification tokens.

9. The system of claim 8, further comprising a notification component that conveys an identification token to a referral originating device.

10. The system of claim 9, wherein the notification component further conveys a compensation notification to a referring agent

11. The system of claim 3, further comprising a signature component that facilitates identification of the referring agent.

12. The system of claim 3, wherein the privacy component includes a component that facilitates generating a privacy profile.

13. A method for intent-based peer-to-peer referral and compensation, the method comprising:
receiving a referral, the referral associated with a commercial intent;
tracking a referring agent;
engaging in a transaction with the referred agent;
assessing the legitimacy of the referral associated with the referred agent that has engaged in the transaction;
compensating the referring agent when a referral is legitimate; and
compensating the referred agent based on a conveyed commercial intent.

14. The method of claim 13, receiving a referral further comprising:
gathering information associated with the referred agent; and
assessing the gathered information is compatible with privacy profile for the referred agent.

15. The method of claim 14, further comprising storing the gathered information.

16. The method of claim 14, further comprising inferring a set of potential referrals based at least in part on the gathered information.

17. The method of claim 14, wherein the privacy profile is generated by the referred agent.

18. The method of claim 13, further comprising tracking the referred agent.

19. The method of claim 18, wherein tracking the referring agent includes:
issuing an identification token for the referring agent;
storing the issued identification token; and
providing the issued identification token for a referring agent to a referral originating device.

20. A computer program product comprising a computer-readable medium comprising code stored thereon that, when executed by a computer, causes the computer to carry out the following acts:
receiving a referral, the referral associated with a commercial intent;
tracking a referring agent;
tracking a referred agent;
engaging in a transaction with the referred agent;
assessing the legitimacy of the referral associated with the referred agent that has engaged in the transaction;
compensating the referring agent when a referral is legitimate, wherein a compensation is funded through ad spend; and
compensating the referred agent based on a conveyed commercial intent, wherein the compensation is funded through ad spend.
